(19) United States
(12) Patent Application Publication
(10) Pub. No.: US 2011/0276260 A1
(43) Pub. Date: Nov. 10, 2011

(54) AUTOMOBILE FUEL PERFORMANCE CALCULATION APPARATUS AND METHOD THEREOF

(75) Inventor: Song Sim, Gyeonggi-do (KR)

(73) Assignee: BLUEPOINT CO., LTD., Anyang-si, Gyeonggi-do (KR)

(21) Appl. No.: 13/062,044

(22) PCT Filed: Sep. 1, 2009
(86) PCT No.: PCT/KR09/04894

§ 371 Date: Jul. 20, 2011

(30) Foreign Application Priority Data
Sep. 3, 2008 (KR) 10-2008-0086903

(51) Int. Cl. B60W 40/10

(52) U.S. Cl. 701/123

(57) ABSTRACT

A vehicle mileage calculation device includes a travel distance calculation unit for calculating a travel distance of a vehicle, an actual fuel consumption amount calculation unit for calculating an actual amount of fuel consumed in an engine, a mileage calculation unit for calculating a mileage based on the travel distance and the actual fuel consumption amount, a stored energy change amount calculation unit for calculating a change amount of stored energy including one of kinetic energy, potential energy and electric energy, and a consumed energy amount calculation unit for calculating an amount of energy consumed when storing the stored energy.

### FIELD OF THE INVENTION

The present invention relates to a vehicle mileage calculation device and method and more particularly, to a technique of calculating a fuel consumption rate of a fuel vehicle provided with an engine that generates power using a oxidizing thermal energy of fuel such as gasoline, diesel oil, liquefied petroleum gases, ethanol or hydrogen.

### BACKGROUND ART

A fuel vehicle essentially includes en engine for generating power, a power train for transferring the power to wheels, a generator operatively connected to the power train and a battery electrically connected to the generator. The term “fuel vehicle” used herein is intended to include a hybrid vehicle that generates heat by oxidizing hydrogen.

The engine, is designed to generate power by generating thermal energy from fuel and converting the thermal energy to mechanical energy. The generator is configured to covert the mechanical energy transferred through the power train to electric energy which in turn is charged to the battery or supplied to individual electric devices of the vehicle. The battery serves to feed electric power needed to start up the engine or to supply electric power to electric devices such as an emergency lain and a window actuator before the generator begins to operate or when the output voltage of the generator is lower than the voltage of the battery.

A fuel vehicle manufacturer has an obligation to show a mileage indicating the relationship between a fuel consumption amount and a traveled distance, one of indices indicating vehicle performance, which is measured under a specific travel environment (including, e.g., a vehicle weight, a tire air pressure, a travel speed, a road condition, a road complexity, a wind velocity).

However, the mileage measured under the specific travel environment is not suitable for a driver, who drives, a vehicle under different travel conditions, to determine whether the fuel is consumed in an efficient manner. In view of this, there has been developed and used a vehicle mileage, calculation device for calculating and notifying a mileage reflecting actual travel conditions on a real time basis.

FIG. 5 is a functional block diagram showing conventional vehicle mileage calculation device. As shown in FIG. 5, the conventional vehicle mileage calculation device includes a memory (not shown), a travel distance calculation unit 111 for calculating a travel distance and storing the calculated travel distance in the memory, an actual fuel consumption amount calculation unit 113 for calculating an actual fuel consumption amount consumed by an engine and storing the calculated fuel consumption amount in the memory and a mileage calculation unit 140 for calculating a mileage by comparing the travel distance with the actual fuel consumption amount.

The travel distance calculation unit 111 is configured to calculate the travel, distance of a vehicle by counting the signals (analog signals) inputted from a vehicle speed sensor 112 or integrating the signals (digital signals).

The actual fuel consumption amount calculation unit 113 is designed to calculate an actual fuel consumption amount using a detection value supplied from a level sensor or a pressure sensor arranged within a fuel tank or a detection value supplied from a flow rate sensor arranged in a fuel injection unit.

The fuel, fed from the fuel tank to the engine is converted to mechanical energy in an engine output unit. The mechanical energy is partially consumed while driving wheels and partially converted to electric energy by a generator. The electric energy is consumed in electric devices of the vehicle.

In addition, the mechanical energy converted in the engine output unit is partially stored in the form of kinetic energy (increased travel speed) or a potential energy (increased vehicle altitude) and partially stored in the battery in the form of electric energy.

Even if the fuel supplied to the engine is cut during travel, the vehicle can run for a while by consuming the kinetic energy or the potential energy stored in the vehicle.

The mileage calculation unit 140 is configured to calculate a distance/fuel type mileage by dividing the travel distance by the actual fuel consumption amount or a fuel/distance type mileage by dividing the actual fuel consumption amount by the travel distance. The mileage calculated in the mileage calculation unit 140 is indicated on a display unit 114 arranged in front of a driver.

In the conventional vehicle mileage calculation device, however, the mileage is calculated without giving any consideration to the fact that the mechanical energy converted by the engine may be partially stored in the form of kinetic energy, potential energy or electric energy and may be reused to drive the vehicle. Thus, the mileage is changed in such a simple pattern that it decreases upon pressing an accelerator pedal but increases upon releasing the accelerator pedal. The mileage becomes infinite if the fuel supplied to the engine is cut during travel (This is because, even it the fuel supplied to the engine is cut during travel, the vehicle can run for a while by consuming the kinetic energy or the potential energy stored in the vehicle.

For the reasons noted above, the conventional vehicle mileage calculation device fails to notify a driver of the relationship between a travel distance and a fuel consumption amount calculated by reflecting the driving conditions such as a travel speed or an accelerating state and the operating conditions of electric devices such as an air conditioner or the like.

### DETAILED DESCRIPTION OF THE INVENTION

### Technical Problems

It is therefore an object of the present invention to provide a vehicle mileage calculation device capable of calculating the relationship between a travel distance and a fuel consumption amount, by reflecting the driving conditions or the operating conditions of electric devices.

### Solution to the Technical Problems

In one aspect of the present invention, there is provided a vehicle mileage calculation device, including:

a travel distance calculation unit for calculating a travel distance of a vehicle during a predetermined travel distance calculation period;

an actual fuel consumption amount calculation unit for calculating an actual amount of fuel consumed in an engine during a fuel consumption amount calculation period coinciding in start point and length with the travel distance calculation period;

a mileage calculation unit for calculating a mileage based on the travel distance calculated in the travel distance calculation unit and the actual fuel consumption amount calculated in the actual fuel, consumption amount calculation unit;

a stored energy change amount calculation unit for calculating a change amount of stored energy including at least one of kinetic energy stored in the vehicle, potential energy stored in the vehicle and electric energy stored in a battery during an energy change amount calculation period coinciding in length with the fuel consumption amount calculation period; and

a consumed energy amount calculation unit for calculating an amount of energy consumed when storing the stored energy, during a consumed energy calculation period coinciding in start point and length with the energy change amount calculation period,

wherein the mileage calculation unit is configured to calculate the mileage by calculating a stored energy fuel consumption amount through conversion of the stored energy change amount calculated in the stored energy change amount calculation unit to a fuel amount consumed in the engine, calculating a consumed energy fuel consumption amount through conversion of the consumed energy amount calculated in the consumed energy amount calculation unit to a fuel amount consumed in the engine, calculating an effective fuel consumption amount through subtraction of the stored energy fuel consumption amount and the consumed energy fuel consumption amount from the actual fuel consumption amount calculated in the actual fuel consumption amount calculation unit, and comparing the effective fuel consumption amount with the travel distance calculated in the travel distance calculation unit.

The vehicle mileage calculation device may further include:

a memory for storing dynamic energy storage efficiency indicative of a ratio of mechanical energy transferred to wheels to mechanical energy generated in an engine output unit when a generator is removed from the engine output unit and electric energy storage efficiency indicative of a ratio of electric energy charged in the battery to the mechanical energy generated in the engine output unit when a power train is removed from the engine output unit with the generator connected to the engine output unit,

wherein the stored energy change amount calculation unit is configured to calculate the stored energy change amount based on the dynamic energy storage efficiency, the electric energy storage efficiency and the mechanical energy generated in the engine output unit during travel, the stored energy change amount calculation unit being configured to calculate the consumed energy amount based on the dynamic energy storage efficiency, the electric energy storage efficiency and the mechanical energy generated in the engine output unit during travel.

In the vehicle mileage calculation device, the energy change amount calculation period may have a start point lagging behind, the fuel consumption amount calculation period by a storage time taken for engine power to be converted to and stored as the stored energy.

In another aspect of the present invention, there is provided a vehicle mileage calculation method, including the steps of:

calculating a travel distance of a vehicle during a predetermined travel distance calculation period;

calculating an actual amount of fuel consumed in an engine during a fuel consumption amount calculation period coinciding in start point and length with the travel distance calculation period;

calculating a mileage based on the travel distance and the actual fuel consumption amount;

calculating a change amount of stored energy including least one of kinetic energy stored in the vehicle, potential energy stored in the vehicle and electric energy stored in a battery during an energy change amount calculation period coinciding in length with the fuel consumption amount calculation period; and

calculating an amount of energy consumed when storing the stored energy, during a consumed energy calculation period coinciding in start point and length with the energy change amount calculation period,

wherein the step of calculating the mileage includes calculating a stored energy fuel consumption amount through conversion of the stored energy change amount to a fuel amount consumed in the engine, calculating a consumed energy fuel consumption amount through conversion of the consumed energy amount to a fuel amount consumed in the engine, calculating an effective fuel consumption amount through subtraction of the stored energy fuel consumption amount and the consumed energy fuel consumption amount from the actual fuel consumption amount, and comparing the or fuel consumption amount with the travel distance.

### Advantageous Effects

With the vehicle mileage calculation device of the present invention, a mileage is calculated in view of the mechanical energy generated by an engine and, stored as kinetic energy, potential energy or electric energy. This makes it possible to notify a driver of the relationship between a travel distance and a fuel consumption amount calculated by reflecting the driving conditions such, as a travel speed or an accelerating state and the operating conditions of electric devices such as an air conditioner or the like.

### BRIEF DESCRIPTION OF THE DRAWINGS

FIG. 1 is a functional block diagram showing a vehicle mileage calculation device in accordance with one embodiment of the present invention.

FIG. 2 is a functional block diagram of a stored energy change calculation unit employed in the vehicle mileage calculation device shown in FIG. 1.

FIG. 3 is a view representing the relationship between different calculation periods in the present vehicle mileage calculation device.

FIG. 4 is a view showing how to actually measure energy storage efficiency in the present vehicle mileage calculation device.

FIG. 5 is a functional block diagram showing a conventional vehicle mileage calculation device.

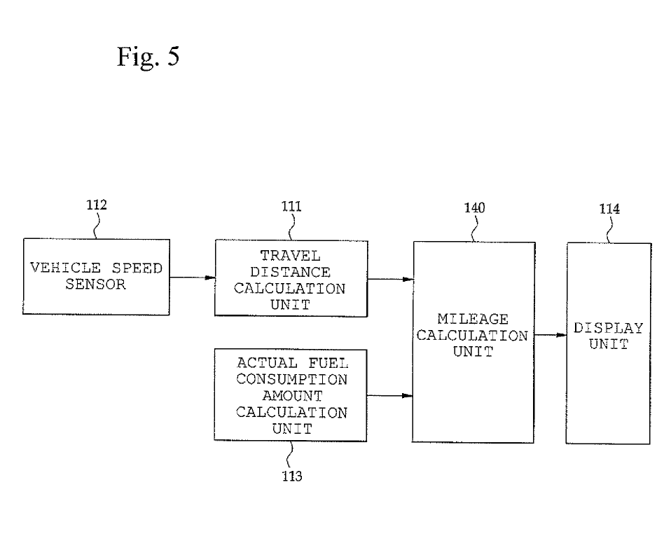

### BEST MODE FOR CARRYING OUT THE INVENTION

One preferred embodiment of vehicle mileage calculation device in accordance with the present invention will now be described with reference to the accompanying drawings.

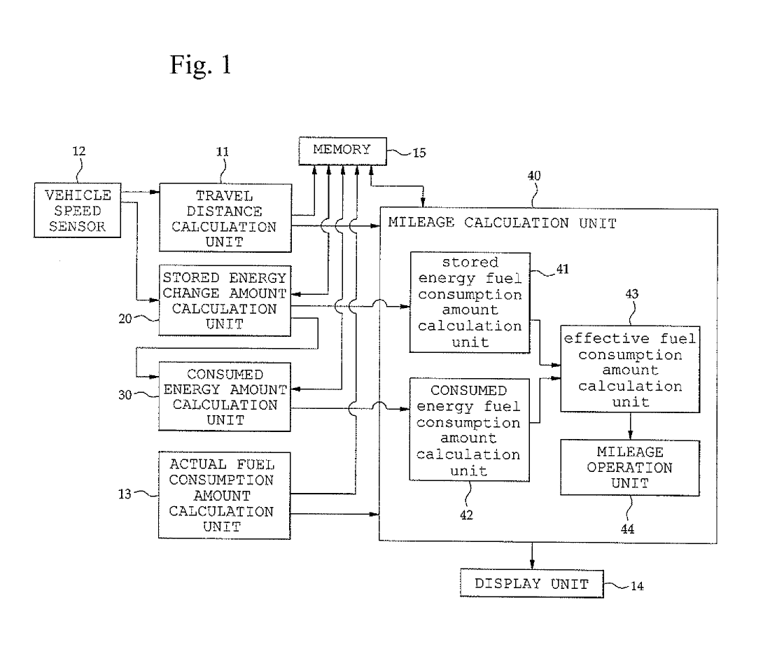

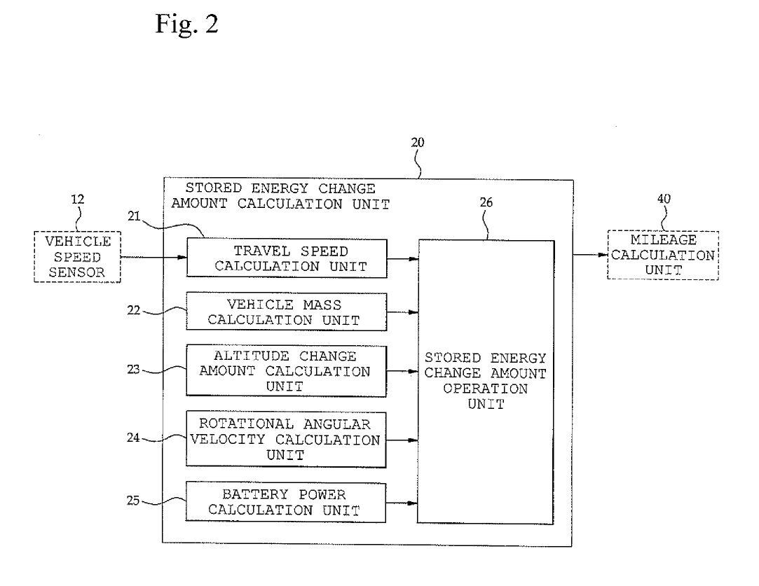

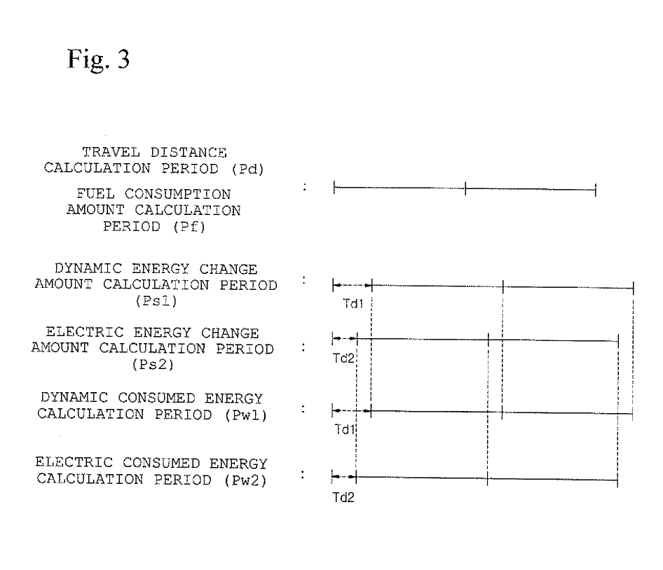

Referring to FIGS. 1 through 4, the vehicle mileage calculation device of the present invention includes a memory 15, a travel distance calculation unit 11 for calculating a travel distance during a travel distance calculation period (Pd) and storing the travel distance in the memory 15, an actual fuel consumption amount calculation unit 13 for calculating an actual fuel consumption amount during a fuel consumption amount calculation period (Pf) and storing the actual fuel consumption amount in the memory 15, a stored energy change amount calculation unit 20 for calculating a vehicle-stored energy change amount during a energy change amount calculation period (Ps) and storing the vehicle stored energy change amount in the memory 15, a consumed energy amount calculation unit 30 for calculating a consumed energy amount during consumed energy amount calculation periods (Pw1 and Pw2) and storing the consumed energy amount in the memory 15 and a mileage calculation unit 40 for calculating a mileage based on the travel distance, the actual fuel consumption amount, the vehicle stored energy change amount and the consumed energy amount stored in the memory 15.

In the memory 15, there are stored a travel distance calculation period (Pd), a dynamic energy storing time (Td1), an electric energy storing time (Td2), a fuel amount-energy conversion coefficient, a stored energy-consumed energy conversion coefficient and rotational inertia moments of rotating components arranged in a power train.

The travel, distance calculation period (Pd) may be arbitrarily set and stored in the memory 15 prior to delivering a vehicle from a factory. Preferably, the travel distance calculation period (Pd) is set to a short time period of one second or less in order to display the mileage on a real time basis.

The dynamic energy storing time (Td1) means the time taken for the mechanical energy generated in an engine to be transferred to wheels and stored as dynamic energy (namely, kinetic energy and a potential energy). The dynamic energy storing time (Td1) is actually measured and stored in the memory 15 prior to delivering a vehicle from a factory.

Since the kinetic energy and the potential energy of a vehicle are transferred through the same energy transfer route, one and the same energy storing time may be applied, to the kinetic energy and the potential energy.

The electric energy storing time (Td2) signifies the time taken for the mechanical energy generated in an engine to be transferred to a battery and stored as electric energy. The electric energy storing time (Td2) is actually measured and stored in the memory 15 prior to delivering a vehicle from a factory.

The dynamic energy storing time (Td1) and the electric energy storing time (Td2) can be found by an engineering modeling method or an actual measurement test.

The fuel amount-energy conversion coefficient is given by 1/(K₀ηₘ), where K₀ is the energy generated when a unit amount of fuel is burned or oxidized and ηₘ is the engine efficiency.

The stored energy-consumed energy conversion coefficient is given by (1−ηₖ)/ηₖ in case of the kinetic energy and the potential energy but by (1−ηₖ)/ηₑ in case of the electric energy, where r is the dynamic energy storage efficiency and ηₑ is the electric energy storage efficiency.

The dynamic energy storage efficiency and the electric energy storage efficiency are actually measured and stored in the memory 15 prior to delivering a vehicle from a factory.

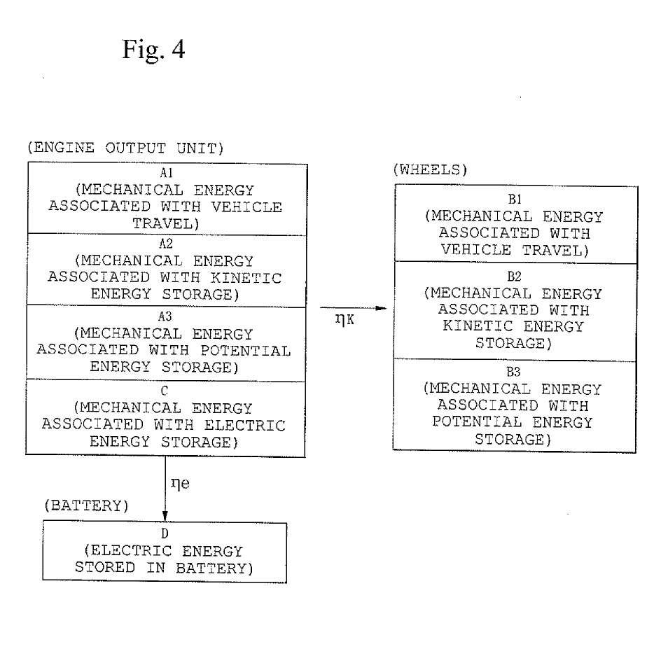

The dynamic energy storage efficiency ηₖ can be actually measured in the following manner (see FIG. 4).

First, fuel is supplied to an engine with a generator removed from a vehicle. Then, the mechanical energy (A) generated in an engine cutout unit and the mechanical energy (B) applied to wheels are actually measured (to find the product of rotation speed and torque).

The mechanical energy (A) generated in an engine output unit is the sum of the mechanical energy (A1) associated with vehicle travel, the mechanical energy (A2) associated with kinetic energy storage and the mechanical energy (A3) associated with potential energy storage.

The mechanical energy (B) applied to wheels is the sum of the mechanical energy (B1) associated with vehicle travel, the mechanical energy (B2) associated with kinetic energy storage and the mechanical energy (B3) associated with potential energy storage.

In this regard, the mechanical energy (A1) and (B1), the mechanical energy (A2) and (B2) and the mechanical energy (A3) and (B3) are respectively transferred through the same energy transfer routes. Therefore, B1/A1 is equal to B2/A2, which is equal to B3/A3, which is equal to B/A.

Thus, the dynamic, energy storage efficiency ηₖ (−B2/A2=B3/A3) can be obtained by dividing the mechanical energy (B) applied to wheels by the mechanical energy generated in an engine output unit.

The electric energy storage efficiency ηₑ can be actually measured in the following manner (see FIG. 4).

First, a transmission is removed from a clutch and a generator is connected to the clutch. Then, a battery is connected to the generator.

Subsequently, the mechanical energy (C) generated in the engine output unit and the electric energy (D) stored in the battery are actually measured. The electric energy (D) stored in the battery can be measured by a voltmeter and an ammeter.

Finally, the electric energy storage efficiency ηₑ can be obtained by dividing the electric energy (D) stored in the battery by the mechanical energy (C) generated in the engine output unit.

The rotational inertia moments are measured or calculated for all the rotating components on a drive shaft and stored in the memory 15 prior to delivering a vehicle from a factory.

The travel distance, calculation unit 11 is configured to calculate the travel distance of a vehicle by counting the signals (analog signals) inputted from a vehicle speed sensor 12 or integrating the signals (digital signals).

The actual fuel consumption amount calculation unit 13 is designed to calculate the actual fuel consumption amount during the fuel consumption amount calculation period (Pf) by converting a detection value supplied from a level sensor or a pressure sensor arranged within a fuel tank or a detection value supplied from a flow rate sensor arranged in a fuel injection unit. The fuel consumption amount calculation period (Pf) coincides in start point and length with the travel distance calculation period (Pd).

The stored energy change amount calculation unit 20 includes a travel speed calculation unit 21 for, calculating travel speeds of the vehicle at start and an end points of a dynamic energy change amount calculation period (Ps1), a vehicle mass calculation unit 22 for calculating a total mass of the vehicle, an altitude change amount calculation unit 23 for calculating an altitude change amount of the vehicle at the start and an end points of the dynamic energy change amount calculation period (Ps1), a rotational angular velocity calculation unit 24 for calculating rotational angular velocities of rotating components on a power train at the start and an end points of the dynamic energy change amount calculation period (Ps1), a battery power calculation unit 25 for calculating charge power and discharge power of the battery during an electric energy change amount calculation period (Ps2) and a stored energy change amount operation unit 26 for operating stored energy change amounts during the dynamic energy change amount calculation period (Ps1) and the electric energy change amount calculation period (Ps2). In this regard, the dynamic energy change amount calculation period (Ps1) coincides in length with the fuel consumption amount calculation period (Pf) but has a start point lagging behind the start point of the fuel on amount calculation period (Pf) by a dynamic energy storing time (Td1). The electric energy change amount calculation period (Ps2) coincides in length with the fuel consumption amount calculation period (Pf) but has a start point lagging behind the start point of the fuel consumption amount calculation period (Pf) by an electric energy storing time (Td2).

If coils springs are used as a suspension device, the vehicle mass calculation unit 22 can be configured as follows. The coil springs are assumed to be four in number, two of which are installed between a front axle and a frame and the remaining two of which are installed between a rear axle and the frame.

Displacement sensors are arranged in the respective coil springs to measure the deformed length of the coils springs. Length change amounts are calculated by subtracting the deformed length from the original length of the coil springs. Load change amounts are calculated by multiplying the length change amounts by a spring constant of the coil springs. A total load change amount is found by adding up the load change amounts for the coil springs. The total load change amount is converted to a value having a mass unit and added to the initials mass of the vehicle corresponding to the initial length of the coil springs, thereby finding the total mass of the vehicle. Even if other kinds of elastic bodies than the coil springs are used as the suspension device, the total mass of the vehicle can be calculated in the same manner as noted above. This is because the elastic bodies differ from the coil springs only in terms of a spring constant.

The travel speed calculation unit 21 can be configured to calculate the travel speeds at the start and end points of she dynamic energy change amount calculation period (Ps1) by taking a start point speed value inputted from the vehicle speed sensor 12 at the start point of the dynamic energy change amount calculation period (Ps1) and an end point speed value inputted from the vehicle speed sensor 12 at the end point of the dynamic energy change amount calculation period (Ps1).

The altitude change amount calculation unit 23 can calculate the altitude change amount using an atmospheric pressure sensor or an inclination sensor installed in a vehicle body.

The rotational angular velocity calculation unit 24 can calculate rotational angular velocities for the components arranged ahead of a clutch (or a torque converter) and for she components arranged behind the clutch. A crankshaft, a camshaft and a flywheel are arranged ahead of the clutch. Shift gears, a propeller shaft, differential gears, axles and wheels are arranged behind the clutch.

The rotational angular velocity of the components arranged ahead of the clutch (hereinafter referred to as “upstream components”) can be calculated as follows.

First, the revolution number of the engine is detected. Then, the rotation speed of the upstream components is calculated my multiplying the revolution number of the engine by a reduction ratio of the upstream components. Thereafter, the rotational angular velocity of the upstream components is calculated by multiply in the rotation speed of the upstream components by 2π.

The rotational angular velocity of the components arranged behind the clutch (hereinafter referred to as “downstream components”) can be calculated as follows.

First, the vehicle speed is detected. Then, the rotation speed of the wheels is calculated by dividing the vehicle speed by a travel distance per revolution of the wheels. Subsequently, the rotation speed of the downstream components is calculated by multiplying the rotation speed wheels by a reduction ratio of the downstream components. Thereafter, the rotational angular velocity of the downstream components is calculated by multiplying the rotation speed of the downstream components by 2π.

The battery power calculation unit 25 can calculate the charge power and the discharge power of the battery as follows.

First, a current sensor and a voltmeter are connected to the battery to detect the current value and current flow direction of the battery (by the current sensor) and to detect the voltage value of the battery (by the voltmeter). Then, the current value and the voltage value are integrated during the electric energy change amount calculation period (Ps2). If the electric current flows from the generator toward the battery, it is determined that charge power is inputted to the battery. If the electric current flows in the opposite direction, it is determined that discharge power is outputted from the battery.

The stored energy change amount operation unit 26 operates the stored energy change amounts during the dynamic energy change amount calculation period (Ps1) and the electric energy change amount calculation period (Ps2) in the following manner.

First, the kinetic energy change amount during the dynamic energy change amount calculation period (Ps1) is calculated using equation I:

ΔEₖ=mE(ν₂²−ν₁²)/2+QIᵢ(ωᵢ₂²−ωᵢ₁²)/2,

where m is the total mass calculated in the vehicle mass calculation unit 22, ν₁ and ν₂ are vehicle speeds at the start point, and the end point of the dynamic energy change amount calculation period (Ps1) calculated in the vehicle speed sensor 12, Iᵢ is the rotational inertia moment of the upstream components and the downstream components stored in the memory 15, and ωᵢ₁ and ωᵢ₂ are the rotational angular velocities at the start point and the end point of the dynamic energy change amount calculation period (Ps1).

Next, the potential energy change amount during the dynamic energy change amount calculation period (Ps1) is calculated by equation II:

ΔEₚ=mEgEΔh,

where m is the total mass calculated in the vehicle mass calculation unit 22, g is the acceleration of gravity, and Δh is the altitude change amount calculated in the altitude change amount calculation unit 23 during the dynamic energy change amount calculation period (Ps1).

Subsequently, the electric energy change amount during the electric energy change amount calculation period (Ps2) is calculated by equation III.

$$Δ {E}_{e} = \begin{matrix}{@}^{t 2} \\ {A}_{t 1}\end{matrix} ( {V}_{ei} {EI}_{ei} - {V}_{eo} {EI}_{eo} ) E d t ,$$

where t1 and t2 are the start point and the end point of the electric energy change amount calculation period (Ps2), Vₑᵢ is the battery charge voltage, Vₑₒ is the battery discharge voltage, Iₑᵢ the battery charge current, and Iₑₒ is the battery discharge current.

Finally, the stored energy change amount is calculated by equation

Eₛ=ΔEₖ+ΔEₚ+ΔE_{e,}

The consumed energy amount calculation unit 30 can calculate a consumed energy amount during the consumed energy amount calculation periods (Pw1 and Pw2) in the following manner. The term “consumed energy” used herein means the energy consumed in the process of storing the stored energy. The dynamic consumed energy calculation period (Pw1) coincides in length with the fuel consumption amount calculation period (Pf) but has a start point lagging behind the start point of the fuel consumption amount calculation period (Pf) by a dynamic energy storing time (Td1). The electric consumed energy calculation period (Pw2) coincides in length with the fuel consumption amount calculation period (Pf) but has a start point lagging behind the start point of the fuel consumption amount calculation period (Pf) by an electric energy storing time (Td2).

First, the kinetic energy change amount and the potential energy change amount calculated in the stored energy change amount calculation unit 20 are multiplied by the stored energy-consumed energy conversion coefficient (1−ηₖ)ηₖ to find the consumed energy amount with respect to the kinetic energy change amount and the consumed energy with respect to the potential energy change amount during the dynamic consumed energy calculation period (Pw1).

Then, the electric energy change amount calculated in the stored energy change amount calculation unit 20 are multiplied by the stored energy-consumed energy conversion coefficient (1−ηₑ)ηₑ to find the consumed energy amount with respect to the electric energy change amount during the electric consumed energy calculation period (Pw2).

Finally, the total consumed energy amount during the dynamic consumed energy calculation period (Pw1) and the electric consumed energy calculation period (Pw2) is obtained by adding up the consumed energy amount with respect to the kinetic energy change amount, the consumed energy amount with respect to the potential energy change amount and the consumed energy amount with respect to the electric energy change amount.

The mileage calculation unit 40 includes a stored energy fuel consumption amount calculation unit 41 for calculating a stored energy fuel consumption amount, a consumed energy fuel consumption amount calculation unit 42 for calculating a consumed energy fuel, consumption amount, an effective fuel consumption amount calculation unit 43 for calculating an effective fuel consumption amount, and a mileage operation unit 44 for operating a mileage based on the stored energy fuel consumption amount, the consumed enemy fuel consumption amount and the effective fuel consumption amount.

The stored energy fuel consumption amount calculation unit 41 calculates the stored energy fuel consumption amount by multiplying the stored energy change amount (Es) calculated in the stored energy change amount calculation unit 20 by the fuel amount-energy conversion coefficient 1/(K₀ηₘ) stored in the memory 15.

The consumed energy fuel consumption amount calculation unit 42 calculates the consumed energy fuel consumption amount by multiplying the consumed energy amount calculated in the consumed energy amount calculation unit 30 by the fuel amount-energy conversion coefficient 1/(K₀ηₘ) stored in the memory 15.

The effective fuel consumption amount calculation unit 43 calculates the effective fuel consumption amount by subtracting the stored energy fuel consumption amount calculated in the stored energy fuel consumption amount calculation unit 41 and the consumed energy fuel, consumption amount calculated in the consumed energy fuel consumption amount calculation unit 42 from the actual fuel consumption amount calculated in the actual fuel consumption amount calculation unit 13.

The effective fuel consumption amount becomes smaller than the actual fuel consumption amount if the sum of the stored energy fuel consumption amount and the consumed energy fuel consumption amount is positive, but becomes greater than the actual fuel consumption amount if the sum of the stored energy fuel consumption amount and the consumed energy fuel consumption amount is negative.

The mileage operation unit 44 is configured to calculate a distance/fuel type mileage by dividing the travel distance calculated in the travel distance calculation unit 11 by the effective fuel consumption amount calculated in the effective fuel consumption amount calculation unit 43 or a fuel/distance type mileage by dividing the effective fuel consumption amount by the travel distance. The mileage calculated in the mileage calculation unit 40 is indicated on a display unit 14 arranged in front of a driver.

With the vehicle mileage calculation device of the present invention, described above, a mileage is calculated in view of the mechanical energy generated by an engine and stored as kinetic energy, potential energy or electric energy. This makes it possible to notify a driver of the relationship between a travel distance and a fuel consumption amount calculated by reflecting the driving conditions such as a travel speed or an accelerating state and the operating conditions of electric devices such as an air conditioner or the like.

By calculating a mileage in view of the energy consumed in the process of storing the stored energy, it is possible to accurately notify a driver of the relationship between a travel distance and a fuel consumption amount.

It is also possible to easily calculate a consumed energy amount using the dynamic energy storage efficiency and the electric energy storage efficiency, both of which can be measured in advance.

By setting the energy change amount calculation period so that it can lag behind the fuel consumption amount calculation period by a storage time taken for the engine power to be converted to and stored as the stored energy, it is possible to accurately notify a driver of the relationship between a travel distance and a fuel consumption amount.

### INDUSTRIAL APPLICABILITY

The vehicle mileage calculation device according to the present invention can be used to calculate a mileage of a vehicle in an accurate and reliable manner.

1. A vehicle mileage calculation device, comprising:
a travel distance calculation unit for calculating a travel distance of a vehicle during a predetermined travel distance calculation period;
an actual fuel consumption amount calculation unit for calculating an actual amount of fuel consumed in an engine during a fuel consumption amount calculation period coinciding in start point and length with the travel distance calculation period;
a mileage calculation unit for calculating a mileage based on the travel distance calculated in the travel distance calculation unit and the actual fuel consumption amount calculated in the actual fuel consumption amount calculation unit;
a stored energy change amount calculation unit for calculating a change amount of stored energy including at least one of kinetic energy stored in the vehicle, potential energy stored in the vehicle and electric energy stored in a battery during an energy change amount calculation period coinciding in length with the fuel consumption amount calculation period; and
a consumed energy amount calculation unit calculating an amount of energy consumed when storing the stored energy, during a consumed energy calculation period coinciding in start point and length with the energy change amount calculation period,
wherein the mileage calculation unit is configured to calculate the mileage by calculating a stored energy fuel consumption amount through conversion of the stored energy change amount calculated in the stored energy change amount calculation unit to a fuel amount consumed in the engine, calculating a consumed energy fuel consumption amount through conversion of the consumed energy amount calculated in the consumed energy amount calculation unit to a fuel amount consumed in the engine, calculating an effective fuel consumption amount through subtraction of the stored energy fuel consumption amount and the consumed energy fuel consumption amount from the actual fuel consumption amount calculated in the actual fuel consumption amount calculation unit, and comparing the effective fuel consumption amount with the travel distance calculated in the travel distance calculation unit.

2. The device as recited in claim 1, further comprising:
a memory for storing dynamic energy storage efficiency indicative of a ratio of mechanical energy transferred to wheels to mechanical energy generated in an engine output unit when a generator is removed from the engine output unit and electric energy storage efficiency indicative of a ratio of electric energy charged in the battery to the mechanical energy generated in the engine output unit when a power train is removed from the engine output unit with the generator connected to the engine output unit,
wherein the stored energy change amount calculation unit is configured to calculate the stored energy change amount based on the dynamic energy storage efficiency, the electric energy storage efficiency and the mechanical energy generated in the engine output unit during travel, the stored energy change amount calculation unit being configured to calculate the consumed energy amount based on the dynamic energy storage efficiency, the electric energy storage efficiency and the mechanical energy generated in the engine output unit during travel.

3. The device as recited in claim 1, wherein the energy change amount calculation period has a start point lagging behind the fuel consumption amount calculation period by a storage time taken for engine power to be converted to and stored as the stored energy.

4. A vehicle mileage calculation method, comprising the steps of:
calculating a travel distance of a vehicle during a predetermined travel distance calculation period;
calculating an actual amount of fuel consumed in an engine during a fuel consumption amount calculation period coinciding in start point and length with the travel distance calculation period;
calculating a mileage based on the travel distance and the actual fuel consumption amount;
calculating a change amount of stored energy including at least one of kinetic energy stored in the vehicle, potential energy stored in the vehicle and electric energy stored in a battery during an energy change amount calculation period coinciding in length with the fuel consumption amount calculation period; and
calculating an amount of energy consumed when storing the stored energy, during a consumed energy calculation period coinciding in start point and length with the energy change amount calculation period,
wherein the step of calculating the mileage includes calculating a stored energy fuel consumption amount through conversion, of the stored energy change amount to a fuel amount consumed in the engine, calculating a consumed energy fuel consumption amount through conversion of the consumed energy amount to a fuel amount consumed in the engine, calculating an effective fuel consumption amount through subtraction of the stored energy fuel consumption amount and the consumed energy fuel consumption amount from the actual fuel consumption amount, and comparing the effective fuel consumption amount with the travel distance.
